(19) United States
(12) Patent Application Publication
(10) Pub. No.: US 2010/0275545 A1
(43) Pub. Date: Nov. 4, 2010

(54) FLANGE FOR SELF-SUPPORTING RIGID HOLLOW BODY, METHOD FOR MAKING SUCH A HOLLOW BODY USING SUCH FLANGES, AND EQUIPMENT FOR IMPLEMENTING SAID METHOD

(76) Inventors: Stephan Kumpf, Bienne (CH); Emil Cohnen, Amel (BE)

Correspondence Address: YOUNG & THOMPSON, 209 Madison Street, Suite 500, Alexandria, VA, 22314, US

(21) Appl. No.: 12/741,621

(22) PCT Filed: Oct. 28, 2008
(86) PCT No.: PCT/IB2008/054448

§ 371 Date: Jul. 14, 2010

(30) Foreign Application Priority Data
Nov. 6, 2007 (FR) 0707777

(51) Int. Cl. E04B 2/00; B05D 3/00; B05C 13/00; B21D 47/00

(52) U.S. Cl. 52/588.1; 427/177; 118/500; 29/897.3

(57) ABSTRACT

A flange (6) intended to be part of a self-supporting rigid hollow body having large dimensions and intended for building constructions, including a thin wall (4) having a generally cylindrical shape relative to an axis, made of a coating and resistance material containing concrete or the like and reinforced with fibres, and two such end flanges (6) oriented towards the outside. The flange includes a main portion (9) generally shaped as a flattened hollow cylinder and visible in the body upon completion and a talon (10) extending in an axial direction from a transverse face (11) of the main portion and having inner radial overall dimensions equal to or close to the inner radial overall dimensions of the main portion, and outer radial overall dimensions lower than the outer radial overall dimensions of the main portion. A method and equipment for making such a hollow body using such flanges are also described.

The invention relates to a flange that is designed to be part of a large-dimension, self-supporting, rigid, hollow body that is itself designed for the production of structures, a process for the production of such a hollow body by means of such flanges, and an installation for the implementation of this process.

The document EP 0252072 describes a process and a device for the production of hollow bodies that are made of concrete and that are reinforced with continuous fibers. According to this process, the fibers are impregnated with water, the fibers are passed into a cement milk, the fibers are wound under tension into at least one layer, on a layer that consists of a mixture of cement and chopped fibers, whereby the concrete has been prepared from a siliceous material that has a fine grain size, and the composite product that is thus obtained is hardened at least partially before withdrawing it from said mandrel. The device comprises at least two tanks for the baths for impregnating fibers that can move in a direction that is parallel to the axis of the mandrel, a tilting arm that is equipped with a device for projecting the mixture of cement and chopped fibers and that makes it possible to apply the fibers under tension on the cement-coated mandrel. The hollow body consists of a prestressed concrete that is reinforced with fibers, whereby said concrete consists of a siliceous material that has a fine grain size and that has a fiber content that ranges up to 10% by weight and more of the final product that is obtained.

The document GB 2068820 describes a non-planar body that is reinforced by means of glass fibers. This body is tubular or U-shaped or pseudo-U-shaped. It comprises successive superposed layers. First, the body is produced flat, and then it is shaped as desired in a cooling fixture.

The document BE 1010457A4 describes a process for the production of hollow or flat bodies from cement mortar that is reinforced with fibers that are impregnated with acrylic polymers. In this process, a flange is used at each of the ends of the mandrel, and continuous fibers are wound around the mandrel in the form of fabric or netting that forms a mesh in warp and weft, impregnated with polymers that are preferably previously dried or polymerized, with a cement mortar or any other binder.

The document EP 1433581 describes a structure and a corresponding production installation. It is a matter of obtaining a uniform application of the hardening composition in such a way that the product has a homogeneous surface that reduces the risk of microcracks and that increases the quality and the solidity. In addition, it is proposed to implement natural fibers.

The document WO2006130047 describes an installation for the production of structural modules that comprises a rotary platform on which is installed a template that is reinforced with flanges, coils with continuous and infinite fiber, and a device for the application of hardener, whereby the template is produced so as to be able to be compressed and the flanges to be removable. The device for application of the hardener is attached to a movable carriage that is installed on a straightedge, and it consists of a guide on which is attached a hose with a nozzle for supplying hardener, an oscillating block that is attached to the straightedge ensuring the nozzle a constant perpendicularity with the surface of the template, and an equidistance to the latter and a counterweight. The fiber of the coils is an alkali-resistant fiber, and a device for supplying binder onto the glass fiber that is wound on the template is provided.

The document U.S. Pat. No. 4,592,674 describes a manhole that has end parts of conjugated shapes.

The document FR 2 282 979 describes a process and a machine for the production of three-dimensional modules. A rotary matrix that forms a male mold is provided. This document does not reveal that the module includes annular flanges.

The cited documents, however, attempt to describe an actually operational technique.

The invention takes advantage of the technique of the known field that consists in winding fibers on and around a mandrel while depositing on the latter a coating and resistance material that is based on concrete or the like, able to be deposited in the liquid state and then to harden, so as to form a hollow body that is made of concrete or the like, comprising a thin wall that is generally cylindrical in shape relative to an axis and two end flanges that are directed toward the outside, forming a one-piece unit that has an inside empty space with two end openings, whereby such a body is designed for the production of structures. The purpose of the invention is quite particularly to make this technique truly operational.

In particular, the purpose of the invention is:
To produce flanges of which advantage usefully can be taken,
A process and an installation for the production of hollow bodies that are simple, quick to implement, and inexpensive.

More generally, the ultimate purpose of the invention is the production of modular structures that:
Are adapted to all of the standards and specifications on matters of city planning
Are fire- and corrosion-resistant
Have an excellent level in terms of heat and acoustic insulation
Have minimal upkeep and maintenance
Have a high mechanical strength that is particularly suited to zones with high seismic activity
Are such that they require optionally little—if any—foundation
Are easily transportable from one site to another
Are such that the manufacturing installations can be mounted on vehicles
Are such that they make possible a standardization of the finishing and equipment
Are at the same time progressive, inelastic, and variable
Are sources of savings.

For this purpose, and according to a first aspect, the invention relates to an annular, rigid, concrete flange that is designed to be part of a large-dimension, self-supporting, rigid, hollow body that is designed for the production of structures, comprising a thin wall that is generally cylindrical in shape and that is made of a coating and resistance material that is based on concrete that is reinforced with fibers and two of such end flanges that are directed toward the outside, characterized in that it comprises:
On the one hand, a primary part that is generally in the shape of a flattened hollow cylinder that has attachment means in the form of holes that can work with attachment elements by bolting or screwing, and
On the other hand, a stub, extending in the axial direction from a transverse surface of the primary part, with a radial inside space that is identical or close to the inside radial space of the primary part, and an outside radial space that is small compared to the outside radial space of the primary part, whose annular thickness decreases from the transverse surface of the primary part from which it extends up to its opposite free end, and whose outside surface is provided with contours for hooking the coating and resistance material that is based on concrete that is reinforced with fibers.

According to one characteristic, the holes of the attachment means of the flanges are oblong and thus form position-regulating means.

According to a second aspect, the invention relates to a process for the production of a large-dimension, self-supporting, rigid, hollow body that is designed for the production of structures comprising two end flanges that are directed toward the outside and a thin wall that is generally cylindrical in shape relative to an axis that is made of a coating and resistance material that is based on concrete that is reinforced with fibers, in which:
A mandrel that forms an inside template for the hollow body, flanges, continuous fibers, and coating and resistance material that is based on concrete and is able to be deposited in the fluid state and then to harden are used,
The mandrel with its vertical or approximately vertical axis, a lower flange around the mandrel toward its lower part, and an upper flange around the mandrel toward its upper part are placed on a table that can be driven to pivot around its vertical axis,
The table, the mandrel, and the flanges are driven to rotate, and the fibers are wound around the mandrel with the coating and resistance material by forming the number of layers desired for the desired thickness,
And the thus produced body is extracted from the mandrel,
   characterized by the fact that
End flanges are used as described,
A mandrel that comprises an outside surface with reduced adhesion is used, or said outside surface is coated with an anti-adhesive material, or a deformable mandrel is used in a short run between an expanded state for the production of the hollow body and a retracted state,
The lower flange is placed on the table by locking it in position relative to the latter, and the upper flange is suspended in the upper part of the mandrel, whereby radial play is arranged between the outside surface of the mandrel and the inside surface of the flanges, whereby the two stubs of the two flanges are located opposite one another in the direction of the transverse median plane of the mandrel.

According to one characteristic, the process comprises a stage in which the table is driven to rotate, and the fibers are wound around and on the part of the mandrel that is located between the two flanges with the coating and resistance material by forming a certain number of layers for a desired thickness, followed by a stage in which one or more layers of a thermal and/or soundproofing insulation material are placed on the outside surface of the previously-produced layers, followed by a stage in which the table is driven to rotate, and the fibers are wound around and on the outside surface of the layer(s) of the material for thermal and/or soundproofing insulation and between the two flanges, with the coating and resistance material by forming a certain number of layers for a desired thickness.

According to another characteristic of the process, the fibers are single or in a network.

According to another characteristic of the process, a hollow reserve box, open toward the outside surface of the mandrel and closed elsewhere, is placed and maintained in a fixed manner for the duration of the production on the outside surface of the mandrel at any desired location that is determined in such a way that the cylindrical wall of the hollow body comprises or forms or helps to form housing means, whereby the latter are designed for elements for circulation and/or for distribution of electricity or electronics, or liquid or gaseous fluids.

According to a third aspect, the invention relates to an installation for the implementation of the process that was just described, comprising:
A mandrel,
A table that can also accommodate a mandrel and that can be driven to pivot around its vertical axis by driving means,
Means for winding the fibers around the mandrel and means for depositing the coating and resistance material by forming the number of layers desired for the desired thickness,
Means for maintaining a constant or essentially constant separation between the mandrel and the means for depositing the coating and resistance material,
   characterized by the fact that:
The mandrel has a straight cross-section that is generally square or rectangular, pseudo-square or pseudo-rectangular, trapezoidal or pseudo-trapezoidal in shape, with rounded or broken angles,
On its upper surface, the table comprises means for locking in position the lower flange and sliding guide means of the bodies that are produced.

According to one characteristic, the mandrel is deformable in a short run between an expanded state for the production of the hollow body and a retracted state for the relative extraction of the body relative to the mandrel, and the installation comprises means for maneuvering said deformation and means for controlling said maneuvering means.

According to one characteristic, the walls of the mandrel are articulated and arranged in a deformable way between an expanded state in which the walls are planar and a retracted state in which the walls form a flattened V between them.

According to one characteristic, the mandrel comprises an inside resistance structure and an outside deformable structure, and means for inflating the outside structure to bring it into an expanded state, whereby the deformable structure is in a retracted state in which the inflation means are inactive.

The invention will be better understood from reading the detailed disclosure that follows from several embodiments of the invention with reference to the drawings in which:

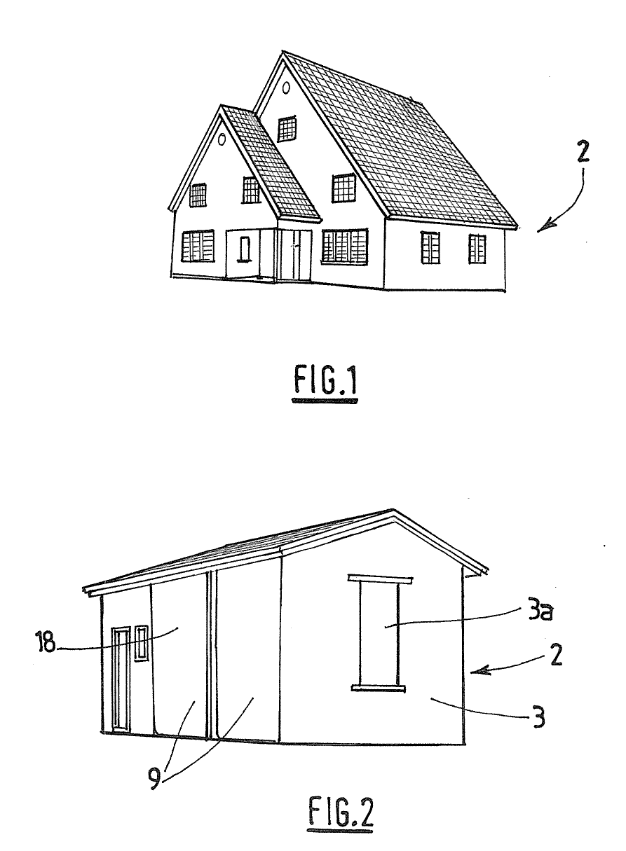

FIG. 1 is a perspective view of the outside of a possible implementation of a structure that is produced according to the invention, in this case a western-type dwelling,

FIG. 2 is a perspective view of the outside of another possible implementation of a structure that is produced in accordance with the invention in which there are visible, on the one hand, two constituent hollow bodies that are juxtaposed by their flanges and placed along a common axis, and, on the other hand, a wall for concealment of the end opening of one of the hollow bodies,

FIG. 3 is a perspective view of the outside of a possible implementation of a unit of hollow bodies that constitute a structure, juxtaposed and superposed,

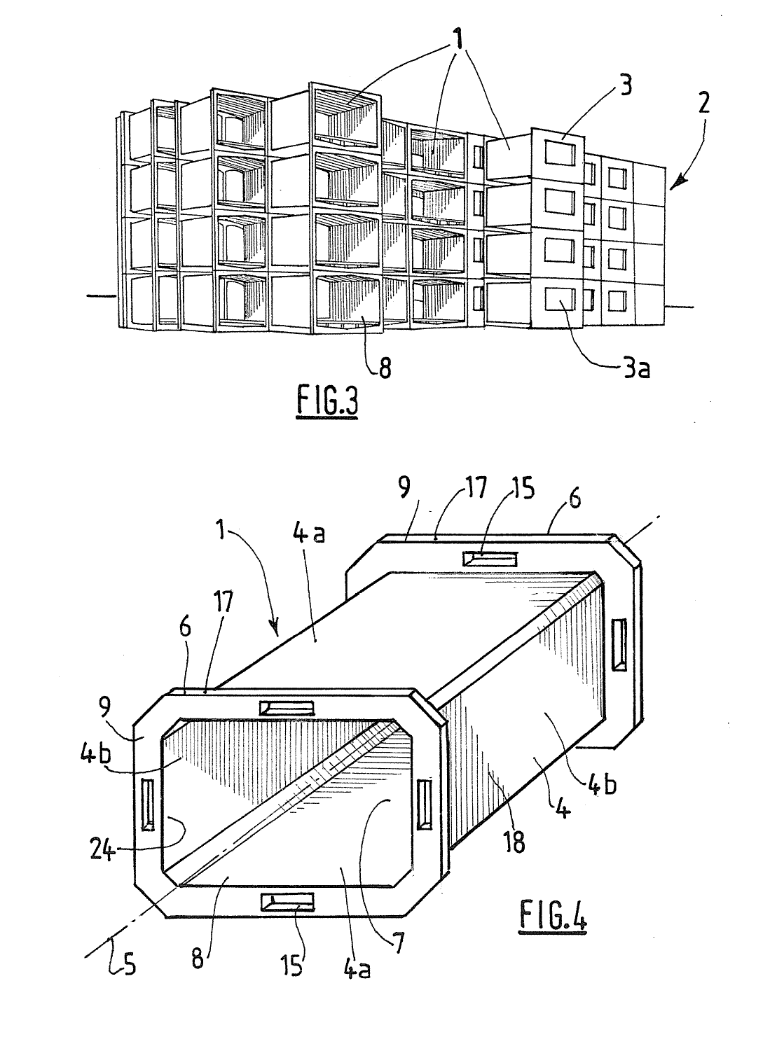

FIG. 4 is a perspective view of the outside of a possible implementation of a self-supporting, rigid, hollow body according to the invention that makes possible the production of structures, whereby the axis of the hollow body is horizontal, as in the structure,

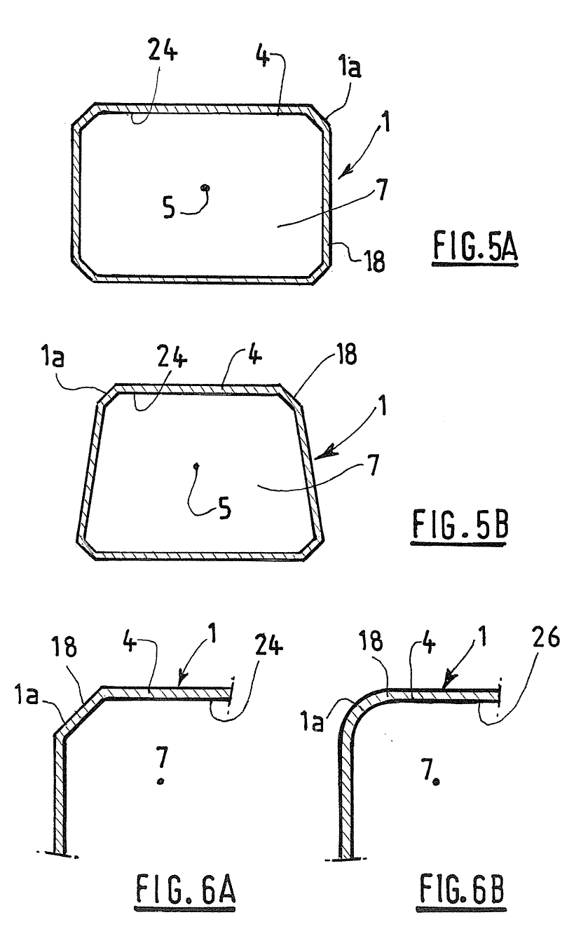

FIGS. 5A and 5B are two diagrammatic cutaway views through a transverse median plane of hollow bodies according to two possible embodiments, with a pseudo-rectangular shape in FIG. 5A and a pseudo-trapezoidal shape in FIG. 5B,

FIGS. 6A and 6B are two partial diagrammatic cutaway views, through a transverse median plane, of hollow bodies according to two possible embodiments, showing a “broken” angle in FIG. 6A and a rounded angle in FIG. 6B,

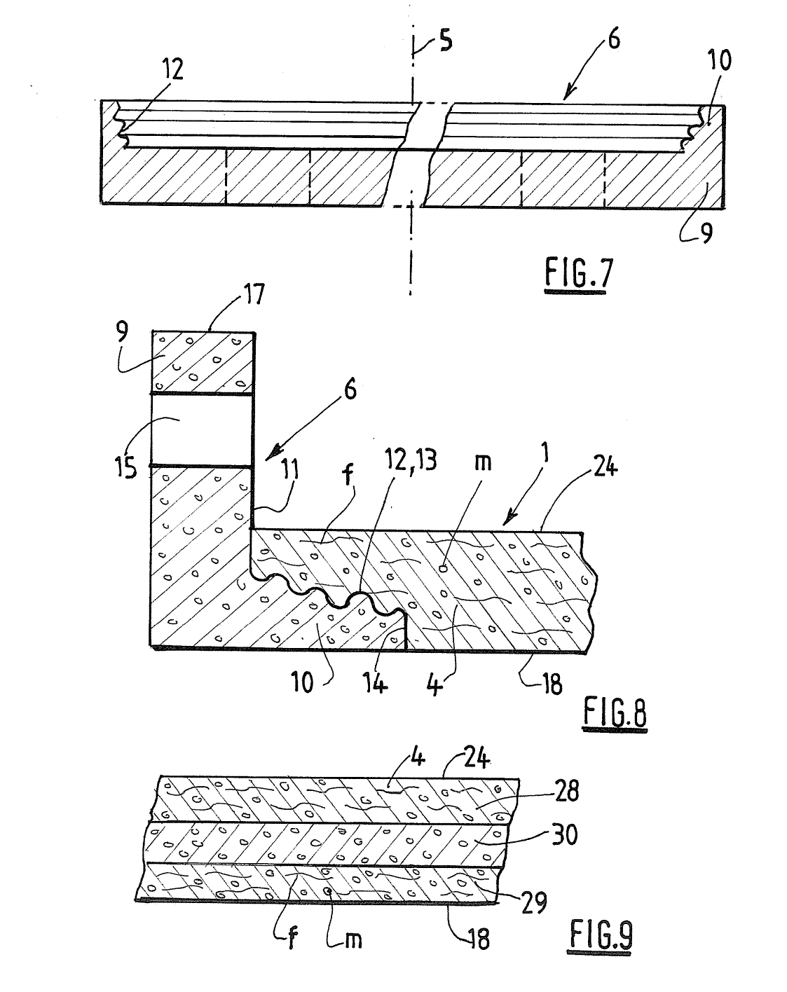

FIG. 7 is a diagrammatic cutaway view through an axial plane of a possible production of a flange that enters the production of a hollow body,

FIG. 8 is a partial diagrammatic cutaway view through an axial plane, showing the stub of a flange and the thin wall of the hollow body, the latter being homogeneous,

FIG. 9 is a partial diagrammatic cutaway view through an axial plane that shows the thin wall of the hollow body, the latter being heterogeneous and including a median insulation part,

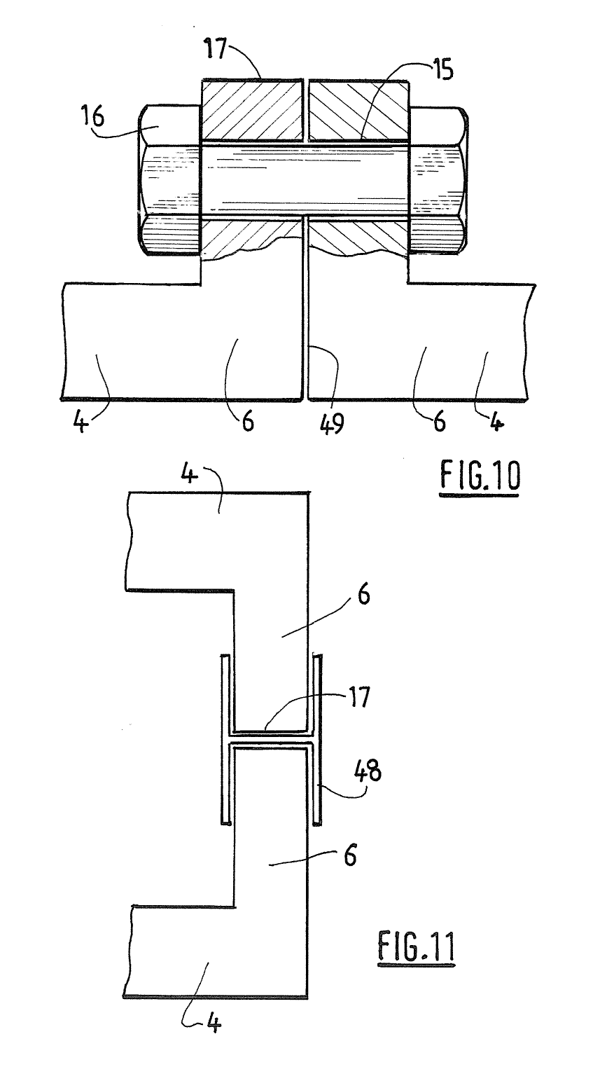

FIG. 10 is a partial diagrammatic cutaway view through an axial plane, showing the rigid combination of two adjacent flanges of two juxtaposed hollow bodies,

FIG. 11 is a partial diagrammatic cutaway view through an axial plane, showing the rigid combination of two adjacent flanges with two superposed hollow bodies,

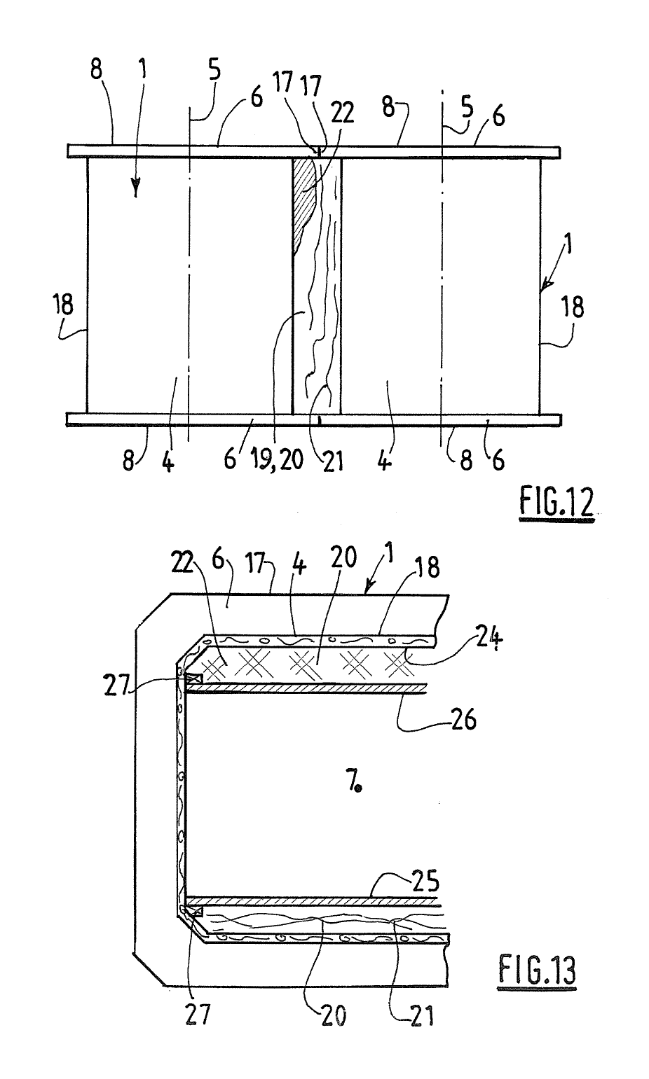

FIG. 12 is a diagrammatic top view of two superposed hollow bodies whose flanges are in contact, whereby a space is arranged between the two hollow bodies outside of each of them,

FIG. 13 is a partial, diagrammatic, cutaway view through a transverse median plane of a possible production of hollow bodies showing the presence of a floor wall and a ceiling wall,

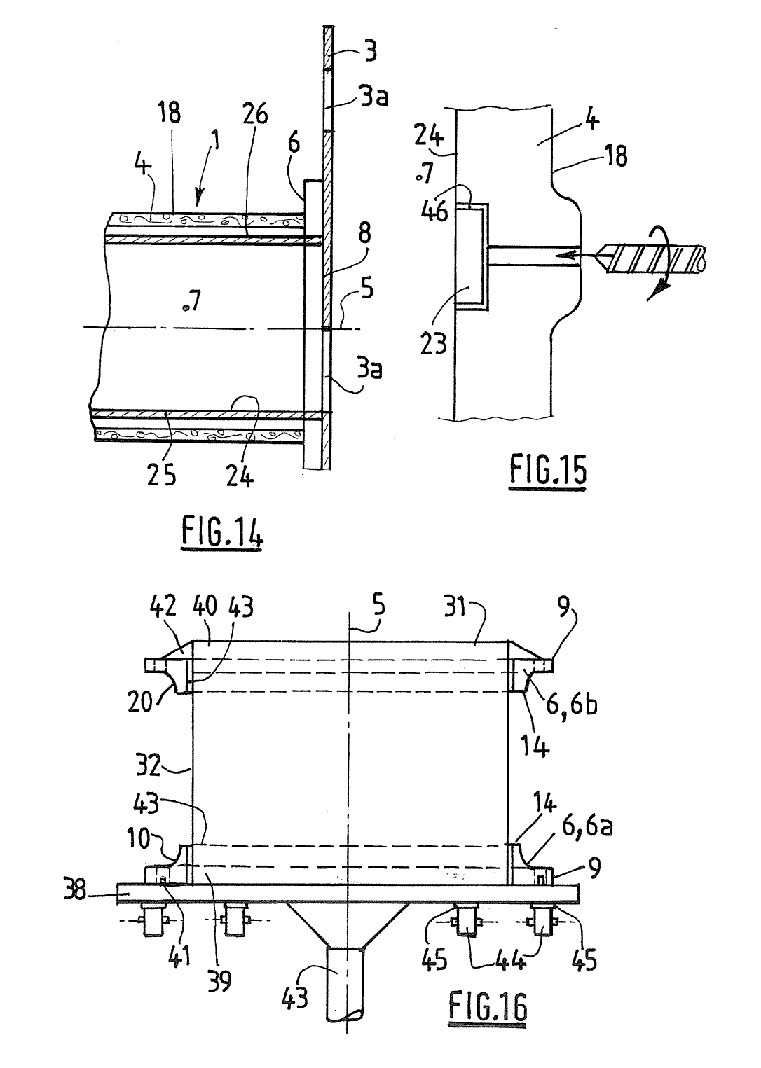

FIG. 14 is a partial, diagrammatic, cutaway view through a vertical axial plane of a possible implementation of hollow bodies with a floor wall, a ceiling wall, and a wall for concealment of the end opening of the hollow body,

FIG. 15 is a partial, diagrammatic, cutaway view through a transverse plane that illustrates the production of a hollow reserve in the cylindrical wall of a hollow body and access to the latter outside of the hollow body,

FIG. 16 is a diagrammatic, cutaway view through a vertical plane that illustrates an installation table according to the invention, whereby the mandrel and the flanges are part of the implementation of a hollow body, in combination with the thin cylindrical wall,

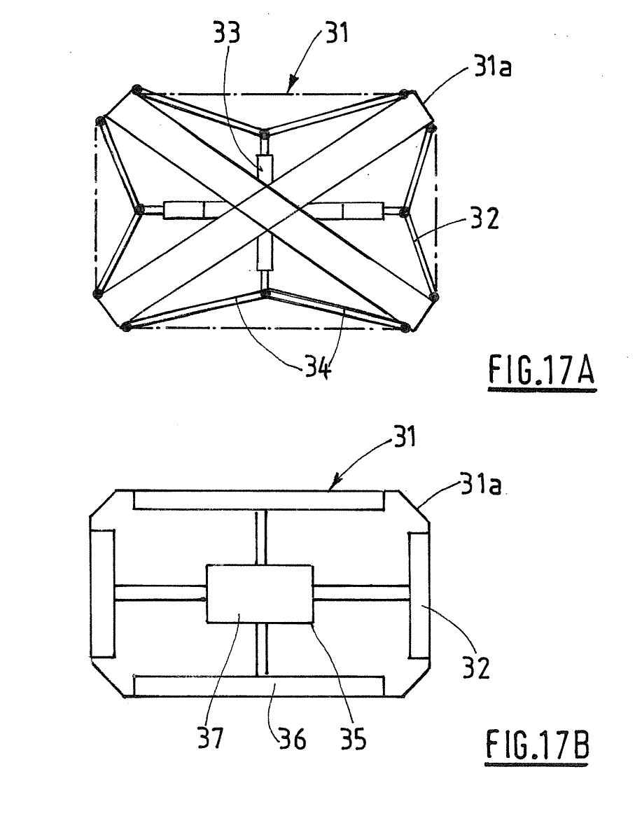

FIGS. 17A and 17B are two transverse, diagrammatic cutaway views of two possible implementations of a mandrel, namely a mandrel that has articulated walls as far as FIG. 17A is concerned, and a mandrel that comprises a deformable inflatable structure as far as FIG. 17B is concerned,

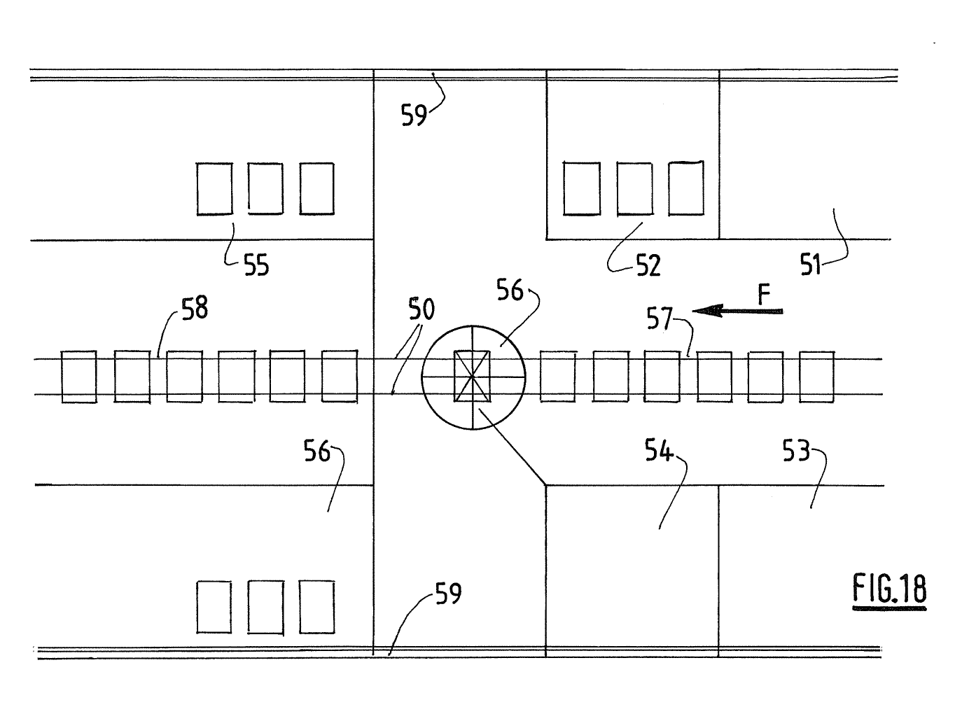

FIG. 18 is a diagrammatic top view of an installation for the implementation of the process.

A large-dimension, self-supporting, rigid, hollow body 1 is designed for the production of self-supporting structures 2 such as buildings for individual or collective use, whose purpose is housing or any other purpose such as, for example, an industrial, commercial, administrative, stocking or storage, or transit building, etc. Such a building has a purpose to be permanent or temporary. The structure can also be a civil engineering work, such as a canal, pipe, bridge, . . . .

Such a structure 2 comprises, as appropriate, a single hollow body 1 or several bodies for the most important structures. It comprises, if necessary, one or more concealment walls 3 that can comprise one or more openings 3a, such as the opening of a door or a window or a passageway.

The same type of hollow body 1 makes possible the production of an infinite variety of structures 2, both by their nature and by their arrangement, and finally their aesthetics.

Such a structure 2 can be produced, i.e., the body or bodies 1 installed, without the necessity of producing foundations, which, combined with the rapidity of assembly, makes the invention well suited to the case where the structures 1 have to be produced immediately.

The hollow body 1 comprises a thin wall 4 that is generally cylindrical in shape relative to an axis 5 and two end flanges 6, directed toward the outside.

The hollow body 1 is one-piece, and it has an inner empty space 7 with two end openings 8 where the flanges 6 are located.

Such a hollow body 1 is made of coating and resistance material that is based on concrete or the like m and that is reinforced with fibers f.

A flange 6 has a general annular shape of axis 5, in correspondence with or adapted to the shape of the cylindrical wall 3.

The flange 6 comprises a primary part 9 and a stub 10 that is manufactured as a single piece.

The primary part 9 is in the general shape of a flattened hollow cylinder, and it is designed to be visible in the hollow body 1 once produced.

The stub 10 extends in the axial direction from a transverse surface 11 of the primary part 9. The stub 10 takes up inside radial space that is identical or close to the inside radial space of the primary part 9. Its outside radial space is small compared to the outside radial space of the primary part 9.

The stub 10 has an outside surface 12 that is provided with contours 13 for hooking for the coating and resistance material that is based on concrete or the like and that is reinforced with fibers that constitute the cylindrical wall 4.

In one embodiment, the stub 10 has a decreasing annular thickness from the transverse surface 11 of the primary part from which it extends up to its opposite free end 14.

In the embodiment that is being considered, such a flange 6 is made of a rigid material such as concrete.

Such a flange 6 comprises, in its primary part 9, attachment means 15 in the form of holes that can work with attachment elements 16 by bolting or screwing.

In one embodiment, the attachment means 15, the flanges 6 of which are provided, include position-regulating means such as oblong holes. This arrangement makes it possible to regulate with precision the relative position of two adjacent analogous hollow bodies 1, juxtaposed in the extension of one from the other, or the relative position of a concealment wall 3 relative to the hollow body that supports it.

These structural arrangements make possible the production of structures 2 in a modular and flexible way.

In contrast, the flanges 6 form—through their peripheral surface 17 of the primary part 9 that projects relative to the extrados 18 of the cylindrical wall 4—means for separation between the extrados 18 of two analogous and adjacent hollow bodies 1 that are in contact by their flanges 6 (FIG. 12). The composition between the two hollow bodies 1 of a space 19 that is located on the outside of said hollow bodies 1 is the result.

According to one embodiment, the flanges 6 comprise or form or help to form removable attachment means of an element for handling the hollow body 1 during its production, its movement, its storage, or its mounting. Such attachment means can come in the form of openings.

According to one embodiment, the cylindrical wall 4 of the hollow body 1 comprises or forms or helps to form housing means 20 for elements 21 for circulation and/or for distribution of electricity or electronics, or liquid or gaseous fluids, but also means of housing of means 22 for thermal insulation and/or soundproofing means.

The space 19 between two hollow bodies 1 constitutes such means 20. These means 20 then consist of a passageway between the extrados 18 of the cylindrical wall 4 and another exogenic wall that is located on the outside of the hollow body 1 that is being considered, namely the extrados 18 of the cylindrical wall 4 of another adjacent hollow body.

These means 20 can also consist of a hollow reserve 23 that is arranged in the soffit 24 of the cylindrical wall 4.

These means 20 can also consist of a passageway that is formed between the soffit 24 of the cylindrical wall 4 and another exogenic wall that is located inside the hollow body. Such a wall is, for example, a wall that is attached to the floor 25 or a wall that is attached to the ceiling 26.

According to one embodiment, the cylindrical wall 4 of the hollow body 1 comprises or forms or helps to form means for positioning and/or attaching functional and/or decorative elements that are designed to be part of the structure 2. Such functional and/or decorative elements are, for example, movable property, pieces of furniture, household appliances or heating appliances, or else elements for circulation and/or for distribution of electricity or electronics, or liquid or gaseous fluids.

According to one embodiment, the soffit 24 of the cylindrical wall 4 of the hollow body 1 comprises or forms or helps to form projecting support means 27, designed to support an attached wall 25 that is able to constitute the floor (false floor) of the structure 2 or an attached wall 26 that is able to constitute the (false) suspended ceiling of said structure 2.

In such a case, there is a space between the soffit of the cylindrical wall and the wall that is attached to the floor or the ceiling, whereby said space forms means 20 of housing for elements 21 for circulation and/or for distribution of electricity or electronics, or liquid or gaseous fluids, and/or the housing of means 22 for thermal insulation and/or soundproofing means, as it was indicated above.

According to one embodiment, the hollow body 1 is made of microconcrete or the like m that is reinforced with continuous glass fibers f or the like that are oriented cylindrically like the cylindrical wall 4, i.e., around the axis 5. Such fibers f are arranged so as to have a slight prestressing.

The microconcrete m and the fibers f are deposited in thin superposed layers so as to reach the desired thickness that is calculated based on desired performance levels.

In such an embodiment, the concrete m is essentially able to absorb the compression stresses while the fibers f are essentially able to absorb the tensile stresses.

In one embodiment (FIG. 8), the hollow body 1 has a homogeneous structure in its thickness, which means that it has a series of layers of concrete m and fibers f as indicated above.

In another embodiment (FIG. 9), the hollow body 1 has a sandwich-type heterogeneous structure in its thickness that comprises an outer part 28 and an inner part 29, each made of microconcrete or the like m that is reinforced with continuous glass fibers or the like f and one or more functional central parts 30 with mechanical or protective reinforcement, in particular thermal insulation or soundproofing.

In one embodiment, the hollow body 1 has a straight cross-section that is generally square or rectangular, pseudo-square or pseudo-rectangular in shape (FIG. 5A), or trapezoidal or pseudo-trapezoidal in shape (FIG. 5B), with “broken” angles 1a (FIG. 6A) or rounded angles 1a (FIG. 6B).

With such an embodiment, and as FIG. 4 shows it, two parts 4a of the cylindrical wall 4 that are face to face and parallel to one another are designed to form the lower part and the upper part, respectively, of the structure 2, and are placed horizontally or approximately horizontally. On the other hand, two other parts 4b of the cylindrical wall 4 that are face to face are designed to form two walls of the structure. These walls are, in the general case, placed vertically or approximately vertically. However, the flexibility of the invention makes it possible to consider inclined walls by means of hollow bodies 1 that have a straight cross-section that is generally trapezoidal or pseudo-trapezoidal in shape (FIG. 5B).

In general, the surfaces of the soffit 24 and the extrados 18 are planar or essentially planar.

In one embodiment, the hollow body 1 has an axial length and transversal dimensions on the order of 3 to 5 meters, and more specifically, an axial length on the order of 4.5 meters and transversal dimensions on the order of 3.3 and 4 meters, respectively.

In one possible embodiment, the hollow body 1 is equipped—from production—with outfitting elements or household furnishings.

The process for the production of such a hollow body 1 is now described.

In this process, an installation is used that comprises a mandrel 31 that forms an inner template for the hollow body 1.

Such a mandrel 31 has an outside surface 32 whose soffit 24 of the hollow body 1 is complementary. Consequently, in line with the hollow body 1, the mandrel 31 has a straight cross-section that is generally square or rectangular, pseudo-square or pseudo-rectangular, trapezoidal or pseudo-trapezoidal in shape with rounded or broken angles 31a (FIGS. 17A and 17B).

Taking into account that when the hollow body 1 is produced, it is carried by the mandrel 31, it is suitable to provide to the axis of the mandrel 31 the same numerical reference as that of the hollow body 1, namely the axis 5.

Such a mandrel 31 is rigid overall. So as not to be too heavy, since it has to be moved, it is preferably essentially hollow and made of a material that is as light as possible, for example wood.

It is understood that it is possible to use different mandrels corresponding to different shapes or dimensions of the hollow body 1 that is to be produced.

The mandrel 31 comprises an outside surface 32 with reduced adhesion on the soffit 24 of the hollow body 1 so as to be able to extract said hollow body 1 from the mandrel 31 without too much difficulty by axial pulling.

For this purpose, either the mandrel 31 comprises an outside surface 32 with reduced adhesion by its very nature or, at the beginning of the process for production, the outside surface 32 of the mandrel 31 is coated by an anti-adhesive or slippery material, for example with a grease base.

In another embodiment, there is a deformable mandrel 31 in a short run, enough to “detach” the outside surface 32 of the mandrel from the soffit 24 of the hollow body 1, between an expanded state for the production of the hollow body 1 and a retracted state in which at least a part of the outside surface 32 of the mandrel is separated from the soffit 24 of the hollow body 1 (FIGS. 17A and 17B).

With such an embodiment, the installation comprises means 33 for maneuvering said deformation of the mandrel 33, as well as means for controlling said maneuvering means 33.

In the embodiment that is depicted in FIG. 17A, the walls 34 of the mandrel 31 are articulated and arranged in a deformable way between an expanded state in which the walls are planar (in dotted lines in the figure) and a retracted state in which the walls between them form a flattened V (in solid lines, whereby the deformation has been accentuated for better understanding).

In the embodiment that is shown in FIG. 17B, the mandrel 31 comprises an inside resistance structure 35 and an outside deformable structure 36, means 37 for inflating the outside structure 36 for bringing it into an expanded state, whereby the deformable structure is in a retracted state in which the inflating means 37 are inactive.

For the production of the process for manufacturing hollow bodies 1, pre-fabricated flanges 6 are used.

Continuous fibers f and coating and resistance material based on concrete or the like m are also used. This material m is able to be deposited in the liquid or pasty fluid state and then to harden quite rapidly.

According to the process, the mandrel 31 is placed with its axis 5 placed vertically or approximately vertically on a table 38 that is part of the installation. This table 38 can be made to pivot around its vertical axis by driving means such as a motorized roller. It is suitable, in line with the mandrel 31, that the table has the reference 5 for the axis reference. This pivoting motion will occur subsequently.

A lower flange 6a is placed around the mandrel 31 toward its lower part 39.

An upper flange 6b is placed around the mandrel 31 towards its upper part 40.

The two stubs 10 of the two flanges 6a and 6b are located opposite one another in the direction of the transverse median plane—in this case horizontal—of the mandrel 31.

The lower flange 6a is placed on the table 38 while locking it in position relative to the latter. For this purpose, 1a comprises—on its upper surface—locking means 41 in the position of the lower flange 6a, working with complementary means of the flange 6a. For example, it may be a matter of projections working with holes of the flange 6a. The upper flange 6b is suspended in the upper part 40 of the mandrel 31 by means of, for example, brackets 42. Radial play 43 is arranged between the outside surface 32 of the mandrel 31 and the inside surface of the flanges 6a and 6b.

The table 38—and therefore the mandrel 31 and the flanges 6a and 6b—are then driven to rotate. By doing so, the fibers f are wound around the part of the mandrel 31 that is located between the two flanges 6a and 6b, with the coating and resistance material m. The number of layers desired for the desired thickness, corresponding to the expected resistance performance levels, is formed.

When this stage is concluded, the thus produced hollow body 1 is extracted from the mandrel 31. The hollow body 1 dries and hardens so as to then be able to be used for the production of a structure 2.

In the case of a hollow body 1 having in its thickness a sandwich-type heterogeneous structure with an outside part 28, an inside part 29, and one or more functional central part(s) 30 (FIG. 9), the process first comprises a stage in which the table 38 is driven to rotate, and the fibers f are wound around and on the part of the mandrel 31 that is located between the two flanges 6a and 6b, with the coating and resistance material m by forming a certain number of layers for a desired thickness.

This stage is followed by another stage in which one or more layers of a thermal and/or soundproofing insulation material are placed on the outside surface of the previously-produced layers in order to produce the central layer(s) 30.

This stage is followed by another stage in which the table 38 is driven to rotate, and the fibers f are wound around and on the outside surface of the layer(s) 30 of the material for thermal and/or soundproofing insulation and between the two flanges 6a and 6b, with the coating and resistance material m by forming a certain number of layers for a desired thickness.

According to the embodiments, the fibers f are “single” or in a network. “Single” is defined as fibers that extend in a single direction and do not form a network.

The process that was just described is implemented by means of an installation that first of all comprises the table 38 that was already mentioned. In addition to the locking means 41, the table 38 comprises sliding guide means of the hollow bodies 1 that are produced, such as rails that are arranged in its upper surface. The table 38 is arranged so as to be able to accommodate the mandrel and the hollow body 1 once produced. For this purpose, in addition to a pivoting axis 43, support rollers 44 on which tracks 45 roll from the lower surface of the table 38 are provided in one embodiment.

In contrast, the installation comprises means for winding the fibers f around the part of the mandrel 31 that is located between the two flanges 6a and 6b and means for depositing the coating and resistance material m by forming the desired number of layers for the desired width. These means can comprise drums for fibers f, soaking vats, tightening means, and means for spraying or projecting the material m. With these latter means, means for guiding spraying means so as to cover the entire outside surface of the mandrel 31, as well as the stubs 10 of the flanges 6a and 6b, can be combined in one embodiment.

In addition, in one embodiment, the installation comprises means for maintaining a constant or approximately constant separation between the mandrel 31 and the means for depositing the coating and resistance material m.

In the embodiment in which the cylindrical wall 4 of the hollow body 1 comprises housing means 20 that consist of a hollow reserve 23 that is arranged in the soffit 24, designed for elements 21 for circulation and/or for distribution of electricity or electronics, or liquid or gaseous fluids, the process is such that a hollow reserve box 46, open toward the outside surface 32 of the mandrel and closed elsewhere, is placed and maintained in a fixed manner for the duration of the production—for example by means of a light adhesive—on the outside surface 32 of the mandrel 31, at any desired location that is determined.

As it was disclosed above, such hollow bodies 1 make it possible to produce an infinite variety of self-supporting structures 2. In such a structure 2, the axis 5 of the cylindrical wall 4 is placed horizontally or approximately horizontally (FIGS. 2, 3, and 4). The upper and lower parts of the structure 2—or the part of the structure 2 that is produced using the hollow body 1—are formed by the two parts 4a that are horizontal or approximately horizontal that face the cylindrical wall 4. The walls of the structure 2—or of the part of the structure 2 that is produced using the hollow body 1—are formed by the two parts 4b, in particular vertical or approximately vertical, which face the cylindrical wall 4.

Such a structure comprises, according to a possible embodiment, at least two adjacent hollow bodies 1 that are juxtaposed or superposed.

According to a possible embodiment, the two hollow bodies 1 are juxtaposed with their coaxial axes 5, whereby the two flanges 6 of the two hollow bodies 1 are opposite one another and attached rigidly to one another by the attachment elements 16 that work with the attachment means 15 (FIG. 10).

According to another possible embodiment, the two hollow bodies 1 are juxtaposed with their axes 5 that form an angle between them, for example an angle that is equal to 90° or approximately 90°, whereby two flanges 6 of the two hollow bodies 1 are adjacent to one another and are combined rigidly with one another, directly or indirectly by means of the connecting parts.

According to a possible embodiment, the two hollow bodies 1 are superposed with their coaxial axes 5, whereby the two flanges 6 of the upper hollow body 1 rest on the two flanges 6 of the lower hollow body 1, and whereby two flanges that are in contact are attached rigidly to one another by specific attachment means 48, such as contoured H-shaped pieces (FIG. 11).

According to a possible embodiment, the structure 2 comprises elements 49 for insulation—against water, air, noise, dust, etc.—that are interposed between two adjacent flanges 6 of two adjacent hollow bodies 1.

As indicated above, a structure 2 can also comprise at least one concealment wall 3 that is provided, if necessary, with one or more openings 3a. Such a concealment wall 3 is attached to a flange 6 of a hollow body 1 of the structure 2. Such a concealment wall 3 constitutes, according to the embodiments, an outside wall (front) or an inside wall (partition) of the structure 2.

As disclosed above, the structure 2 comprises a space 19 between two juxtaposed or superposed adjacent hollow bodies 1, whose peripheral surfaces 17 of the flanges 6 are in contact.

Such a space 19 is either left empty or forms housing means 20 for elements 21 for circulation and/or for distribution of electricity or electronics, or liquid or gaseous fluids, or else housing for means of thermal insulation and/or soundproofing means 22. Thus, the structure 2 is characterized by the combination between, on the one hand, the space 19, and, on the other hand, the cylindrical wall 4 of the hollow body 1 in that it comprises or forms or helps to form the housing means 20.

As disclosed above, the structure 2 can comprise a wall 25, 26 that is attached to a hollow body 1, able to constitute the floor or the suspended ceiling of the structure 2—or the structural part 2 that is produced using the hollow body 1. As indicated, the structure comprises a space between the soffit 24 of the cylindrical wall 4 and the wall that is attached to the floor or the ceiling 25, 26, whereby said space forms housing means for the elements 21 for circulation and/or for distribution of electricity or electronics, or liquid or gaseous fluids, and/or the housing of means of thermal insulation and/or soundproofing means 22.

In one embodiment, the pipes (water, gas) are assembled by electric welding, and connectors are provided for elements for distribution of electricity or electronics.

According to one embodiment, it is possible to produce a structure 2, with a single hollow body 1 that has a surface on the floor that can reach on the order of 20 m² for a body with a volume that can reach 50 m³.

The process for the production of such a self-supporting structure 2 is now described.

According to this process, one or more hollow bodies 1 are first produced that are brought from a situation where, for each one of them, its axis 5 is vertical or approximately vertical—as is the case at the end of the production of the hollow body 1—to a situation where its axis 5 is horizontal or approximately horizontal—as is the case in the structure 2.

If necessary, one or more concealment walls 3 are used.

The site where the structure is to be installed is prepared so that it is able to support one or more hollow bodies 1 having its or their axes 5 placed horizontally or approximately horizontally as indicated.

The hollow body or bodies 1 and the concealment wall(s) 3 are brought to the site where they are to be installed.

The hollow body or bodies 1 is/are installed on the site where it/they is/are to be installed so that it (they) occupies (occupy) the desired location.

If the structure comprises several hollow bodies 1 and/or one or more concealment walls 3, their rigid attachment is ensured.

In this process, the hollow body or bodies 1 is (are) installed without the necessity of producing substantial foundations. However, according to one embodiment, an anchoring of the hollow body or bodies 1 on the site where it/they is/are to be installed is implemented.

A rigid attachment of two adjacent hollow bodies 1 or a concealment wall 3 on a hollow body 1 is ensured with the means 15 for attachment of the flanges 6.

According to one embodiment, the pipes (water, gas) are assembled by electric welding, and the elements for the distribution of electricity or electronics are assembled by connectors.

According to one embodiment, the pipes and the elements for distribution of electricity or electronics are assembled in the space 19 between two juxtaposed or superposed adjacent hollow bodies 1 that form housing means 20 for elements 21 for circulation and/or distribution.

According to one embodiment, elements for insulation—against water, air, noise, dust, etc.—are placed between two adjacent flanges of two adjacent hollow bodies 1.

According to one embodiment, elements 21 for circulation and/or for distribution of electricity or electronics, or liquid or gaseous fluids, and/or means for thermal insulation and/or soundproofing means are placed in the space 19 that is arranged between two juxtaposed or superposed adjacent hollow bodies, whose peripheral surfaces 17 of the flanges are in contact.

According to one embodiment, the cylindrical wall 4 is pierced to the right of a hollow reserve 23 that is arranged in the cylindrical wall 4 to allow communication to the right of this reserve 23 between the latter and the outside of the hollow body (FIG. 15).

FIG. 18 shows a diagrammatic top view of an installation for the implementation of the process.

Two rails 50 that define a working direction (arrow F) are provided. Upstream and from a first side are located a zone 51 of raw materials of flanges and a zone 52 for assembling flanges. Upstream and from the second opposite side are located a zone 53 of raw materials for projecting and a zone 54 for the projecting machine. Downstream and from the first side is located a first zone 55 for assembling equipment to measure (such as kitchens, for example). Downstream and from the second opposite side is located a second zone 56 for assembling equipment to measure (such as bathrooms, for example). The entrance is at 57, and the exits from the finished bodies are at 58 between the zones 55, 56.

1. Annular, rigid, concrete flange (6) that is designed to be part of a large-dimension, self-supporting, rigid, hollow body (1) that is designed for the production of structures (2), comprising a thin wall (4) that is generally cylindrical in shape and that is made of a coating and resistance material that is based on concrete that is reinforced with fibers and two of such end flanges (6) that are directed toward the outside, characterized in that it comprises:
On the one hand, a primary part (9) that is generally in the shape of a flattened hollow cylinder that has attachment means (15) in the form of holes that can work with attachment elements (16) by bolting or screwing, and
On the other hand, a stub (10), extending in the axial direction from a transverse surface (11) of the primary part (9), with a radial inside space that is identical or close to the inside radial space of the primary part (9), and an outside radial space that is small compared to the outside radial space of the primary part (9), whose annular thickness decreases from the transverse surface (11) of the primary part (9) from which it extends up to its opposite free end (14), and whose outside surface is provided with contours for hooking the coating and resistance material that is based on concrete that is reinforced with fibers.

2. Flange according to claim 1, wherein the holes of the attachment means (15) of the flanges (6) are oblong and thus form position-regulating means.

3. Process for the production of a large-dimension, self-supporting, rigid, hollow body (1) that is designed for the production of structures (2) comprising two end flanges (6) that are directed toward the outside and a thin wall (4) that is generally cylindrical in shape relative to an axis (5) that is made of a coating and resistance material that is based on concrete that is reinforced with fibers, in which:
A mandrel (31) that forms an inside template for the hollow body (1), flanges (6), continuous fibers, and coating and resistance material that is based on concrete and is able to be deposited in the fluid state and then to harden are used,
The mandrel (31) with its vertical or approximately vertical axis, a lower flange (6a) around the mandrel (31) toward its lower part, and an upper flange (6b) around the mandrel (31) toward its upper part (40) are placed on a table (38) that can be driven to pivot around its vertical axis,
The table (38), the mandrel (31), and the flanges (6a, 6b) are driven to rotate, and the fibers are wound around the mandrel (31) with the coating and resistance material by forming the number of layers desired for the desired thickness,
And the thus produced body (1) is extracted from the mandrel (31),
wherein
End flanges (6) are used according to claim 1,
A mandrel (31) that comprises an outside surface (32) with reduced adhesion is used, or said outside surface (32) is recoated with an anti-adhesive material, or a deformable mandrel is used in a short run between an expanded state for the production of the hollow body (1) and a retracted state,
The lower flange (6a) is placed on the table (38) by locking it in position relative to the latter, and the upper flange (6b) is suspended in the upper part (40) of the mandrel (31), whereby radial play (43) is arranged between the outside surface (32) of the mandrel (31) and the inside surface of the flanges (6a, 6b), whereby the two stubs (10) of the two flanges (6a, 6b) are located opposite one another in the direction of the transverse median plane of the mandrel (31).

4. Process according to claim 3, characterized by a stage in which the table (38) is driven to rotate, and the fibers are wound around and on the part of the mandrel (31) that is located between the two flanges (6a, 6b) with the coating and resistance material by forming a certain number of layers for a desired thickness, followed by a stage in which one or more layers of a thermal and/or soundproofing insulation material are placed on the outside surface of the previously-produced layers, followed by a stage in which the table (38) is driven to rotate, and the fibers are wound around and on the outside surface of the layer(s) of the material for thermal and/or soundproofing insulation and between the two flanges (6a, 6b), with the coating and resistance material by forming a certain number of layers for a desired thickness.

5. Process according to claim 3, wherein the fibers are single or in a network.

6. Process according to claim 3, wherein a hollow reserve box (46), open toward the outside surface of the mandrel (31) and closed elsewhere, is placed and maintained in a fixed manner for the duration of the production on the outside surface (32) of the mandrel (31) at any desired location that is determined in such a way that the cylindrical wall of the hollow body (1) comprises or forms or helps to form housing means (20), whereby the latter are designed for elements (21) for circulation and/or for distribution of electricity or electronics, or liquid or gaseous fluids.

7. Installation for the implementation of the process according to claim 3, comprising:
A mandrel (31),
A table (38) that can also accommodate a mandrel (31) and can be driven to pivot around its vertical axis by driving means,
Means for winding the fibers around the mandrel (31) and means for depositing the coating and resistance material by forming the number of layers desired for the desired thickness,
Means for maintaining a constant or essentially constant separation between the mandrel (31) and the means for depositing the coating and resistance material,
wherein:
The mandrel (31) has a straight cross-section that is generally square or rectangular, pseudo-square or pseudo-rectangular, trapezoidal or pseudo-trapezoidal in shape, with rounded or broken angles,
On its upper surface, the table (38) comprises means (41) for locking in position the lower flange (6a) and sliding guide means for the bodies (1) that are produced.

8. Installation according to claim 7, wherein the mandrel (31) is deformable in a short run between an expanded state for the production of the hollow body (1) and a retracted state for the relative extraction of the body (1) relative to the mandrel (31) and by the fact that the installation comprises means (33) for maneuvering said deformation and means for controlling said maneuvering means.

9. Installation according to claim 8, wherein the walls (34) of the mandrel (31) are articulated and arranged in a deformable way between an expanded state in which the walls are planar and a retracted state wherein the walls form between them a flattened V.

10. Installation according to claim 9, wherein the mandrel (31) comprises an inside resistance structure (35) and an outside deformable structure (36), and means (37) for inflating the outside structure to bring it into an expanded state, whereby the deformable structure is in a retracted state in which the inflation means (37) are inactive.

11. Process for the production of a large-dimension, self-supporting, rigid, hollow body (1) that is designed for the production of structures (2) comprising two end flanges (6) that are directed toward the outside and a thin wall (4) that is generally cylindrical in shape relative to an axis (5) that is made of a coating and resistance material that is based on concrete that is reinforced with fibers, in which:
A mandrel (31) that forms an inside template for the hollow body (1), flanges (6), continuous fibers, and coating and resistance material that is based on concrete and is able to be deposited in the fluid state and then to harden are used,
The mandrel (31) with its vertical or approximately vertical axis, a lower flange (6a) around the mandrel (31) toward its lower part, and an upper flange (6b) around the mandrel (31) toward its upper part (40) are placed on a table (38) that can be driven to pivot around its vertical axis,
The table (38), the mandrel (31), and the flanges (6a, 6b) are driven to rotate, and the fibers are wound around the mandrel (31) with the coating and resistance material by forming the number of layers desired for the desired thickness,
And the thus produced body (1) is extracted from the mandrel (31),
wherein
End flanges (6) are used according to claim 2,
A mandrel (31) that comprises an outside surface (32) with reduced adhesion is used, or said outside surface (32) is recoated with an anti-adhesive material, or a deformable mandrel is used in a short run between an expanded state for the production of the hollow body (1) and a retracted state,
The lower flange (6a) is placed on the table (38) by locking it in position relative to the latter, and the upper flange (6b) is suspended in the upper part (40) of the mandrel (31), whereby radial play (43) is arranged between the outside surface (32) of the mandrel (31) and the inside surface of the flanges (6a, 6b), whereby the two stubs (10) of the two flanges (6a, 6b) are located opposite one another in the direction of the transverse median plane of the mandrel (31).

12. Process according to claim 4, wherein the fibers are single or in a network.

13. Process according to claim 4, wherein a hollow reserve box (46), open toward the outside surface of the mandrel (31) and closed elsewhere, is placed and maintained in a fixed manner for the duration of the production on the outside surface (32) of the mandrel (31) at any desired location that is determined in such a way that the cylindrical wall of the hollow body (1) comprises or forms or helps to form housing means (20), whereby the latter are designed for elements (21) for circulation and/or for distribution of electricity or electronics, or liquid or gaseous fluids.

14. Process according to claim 5, wherein a hollow reserve box (46), open toward the outside surface of the mandrel (31) and closed elsewhere, is placed and maintained in a fixed manner for the duration of the production on the outside surface (32) of the mandrel (31) at any desired location that is determined in such a way that the cylindrical wall of the hollow body (1) comprises or forms or helps to form housing means (20), whereby the latter are designed for elements (21) for circulation and/or for distribution of electricity or electronics, or liquid or gaseous fluids.
